(19) United States
(12) Patent Application Publication
(10) Pub. No.: US 2024/0205993 A1
(43) Pub. Date: Jun. 20, 2024

(54) RELAY USER EQUIPMENT (UE) RADIO RESOURCE CONTROL (RRC) CONNECTION STATUS INDICATOR

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/287,445

(22) PCT Filed: May 6, 2022
(86) PCT No.: PCT/US2022/028182

§ 371 Date: Oct. 18, 2023

Related U.S. Application Data
(60) Provisional application No. 63/186,574, filed on May 10, 2021.
(60) Provisional application No. 63/222,303, filed on Jul. 15, 2021.

(51) Int. Cl. H04W 76/15; H04W 88/04

(52) U.S. Cl. CPC H04W 76/15; H04W 88/04

(57) ABSTRACT

A relay user equipment (UE) device transmits a Radio Resource Control (RRC) connection status indicator indicating the RRC connection status of the relay UE device to a serving base station. The RRC connection status indicator may be used by a remote UE device to manage relay communication to the base station. In one example, a remote UE device in direct communication with the base station transmits a measurement report to the base station where the measurement report includes measurements only for relay UE devices reporting a RRC connected (RRC CONN) status. The base station manages direct to indirect communication switching at least partially based on the measurement report. In another example, a remote UE device manages relay reselection using a relay candidate prioritization at least partially based on the connection status of candidate relay UE devices.

### CLAIM OF PRIORITY

The present application claims the benefit of priority to Provisional Application No. 63/186,574 entitled “Sidelink L2 Relay Reselection Upon Radio Link Failure”, docket number TPRO 00362 US, filed May 10, 2021, and Provisional Application No. 63/222,303 entitled “Service Continuity Under L2 Sidelink Relying”, docket number TPRO 00363 US, filed Jul. 15, 2021, both assigned to the assignee hereof and hereby expressly incorporated by reference in their entirety.

### FIELD

This invention generally relates to wireless communications and more particularly to management of wireless communication links using relay devices.

### BACKGROUND

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D). In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying and the relay UE device establishes a communication path between the remote UE and a base station (gNB) or cell. In some situations, for example, the UE device may be out of the service area of the base station and the relay UE device provides a communication link routed from such an out-of-coverage (OoC) UE device through a relay UE device to the base station. Where the destination device another UE device (target UE device), the relaying functionality is typically referred to as UE-to-UE (U2U) relaying.

### SUMMARY

A relay user equipment (UE) device transmits a Radio Resource Control (RRC) connection status indicator indicating the RRC connection status of the relay UE device to a serving base station. The RRC connection status indicator may be used by a remote UE device to manage relay communication to the base station. In one example, a remote UE device in direct communication with the base station transmits a measurement report to the base station where the measurement report includes measurements only for relay UE devices reporting a RRC connected (RRC CONN) status. The base station manages direct to indirect communication switching at least partially based on the measurement report. In another example, a remote UE device manages relay reselection using a relay candidate prioritization at least partially based on the connection status of candidate relay UE devices.

### BRIEF DESCRIPTION OF THE DRAWINGS

FIG. 1A is a block diagram of a communication system for an example where a candidate relay UE device transmits an RRC connection status to a remote UE device.

FIG. 1B is a block diagram of a communication system for an example where candidate relay UE devices each transmit an RRC connection status that are received by a remote UE device.

FIG. 1C is a block diagram of the system for an example where the remote UE device transmits a measurement report based on received RRC connection status of the candidate relay UE devices.

FIG. 1D is a block diagram of the system for an example where a remote UE device is connected to the base station through a relayed connection and maintains a candidate relay priority list based, at least partially, on RRC connection status of candidate relay UE devices.

FIG. 2 is a block diagram of an example of a base station.

FIG. 3 is a block diagram of an example of a UE device suitable for use as each of the UE devices.

FIG. 4 is a message diagram for an example of relay link management for direct to indirect switching where the remote UE device sends a measurement report for RRC connected candidate relay UE devices.

FIG. 5 is a message diagram for an example of relay link management where the remote UE device maintains a preferred relay list based on the connection status of candidate relay UE devices

### DETAILED DESCRIPTION

As discussed above, a relay UE device provides connectivity between a remote UE device and a destination which can be another UE device (destination UE device) or a network. Where the destination is the network, the relay provides connectivity to a cell provided by a base station (gNB) of the network. The relayed connection between a remote UE device and target UE device is sometimes referred to as a UE to UE (U2U) relay connection. The relayed connection between a remote UE device and a base station (gNB) is sometimes referred to as a UE to network (U2N) relay connection. In some situations, the ultimate destination is a target UE device through the base station. In conventional systems where the relay connects to a base station (gNB), the relay UE device is required to meet certain criteria to function as a relay. For example, the relay UE device must be in coverage and have a cellular (Uu) communication link to the base station of sufficient quality in order to be available for U2N relaying functions.

Sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes a PC5 link (sidelink) between the remote UE device and the relay UE device and the Uu link between the relay UE device and the gNB.

In some situations, a remote UE device is in direct communication with a base station (gNB) without communicating through a relay UE device and the base station determines that the communication link to the remote UE device should be switched from the direct link to an indirect link through a relay UE device. In making the switch to an indirect link, it may be advantageous for the base station to switch to an indirect relayed link provided by a relay UE device that is in the RRC connected state (RRC CONN). Latency, for example, may be minimized when switching to a relayed connection through a relay UE device in RRC CONN as compared to switching to a relayed connection through a relay UE device in and RRC idle state (RRC IDLE) or an RRC inactive state (RRC INACTIVE). For some of the examples herein, the remote UE device provides a measurement report including measurements only for candidate relay UE devices reporting the RRC CONN state. Therefore, the base station only evaluates candidate relay UE devices in RRC CONN, selects a preferred relay UE device, and sends an RRC reconfiguration message to the remote UE device identifying the preferred relay UE device.

In other situations, a remote UE device is in indirect communication with a base station (gNB) through a relay UE device when a determination is made to perform relay reselection to establish a new relayed communication link to the base station. The remote UE device maintains a candidate relay prioritization list based, at least partially, on the connection states of the candidate relay devices. A candidate relay UE device in the RRC CONN state is prioritized higher than a candidate relay UE device in the RRC INACTIVE state. A candidate relay UE device in the RRC IDLE state has the lowest priority. The prioritization may be based on additional factors. For example, the prioritization may be based on the measured Sidelink Discovery Reference Signal Received Power (SD-RSRP) levels of the discovery signals received from the candidate relay UE devices. The prioritization, therefore, may be based on the combination of the RRC connection status and the SD-RSRP level as well as other criteria. In other cases, the Sidelink Reference Signal Received power (SL-RSRP) levels may be used if the remote UE device is already PC5-RRC connected to the relay UE device.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17).

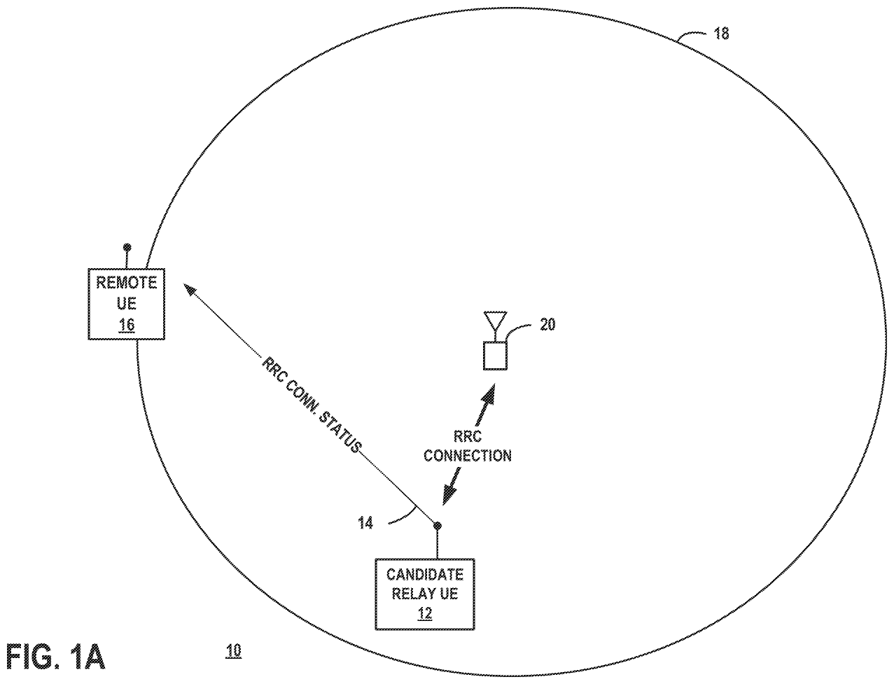

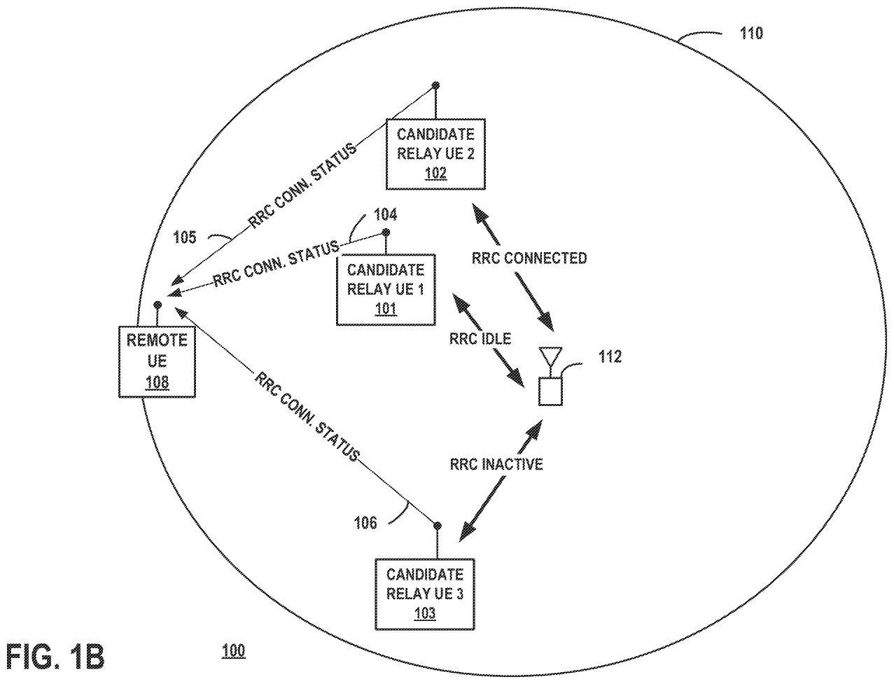

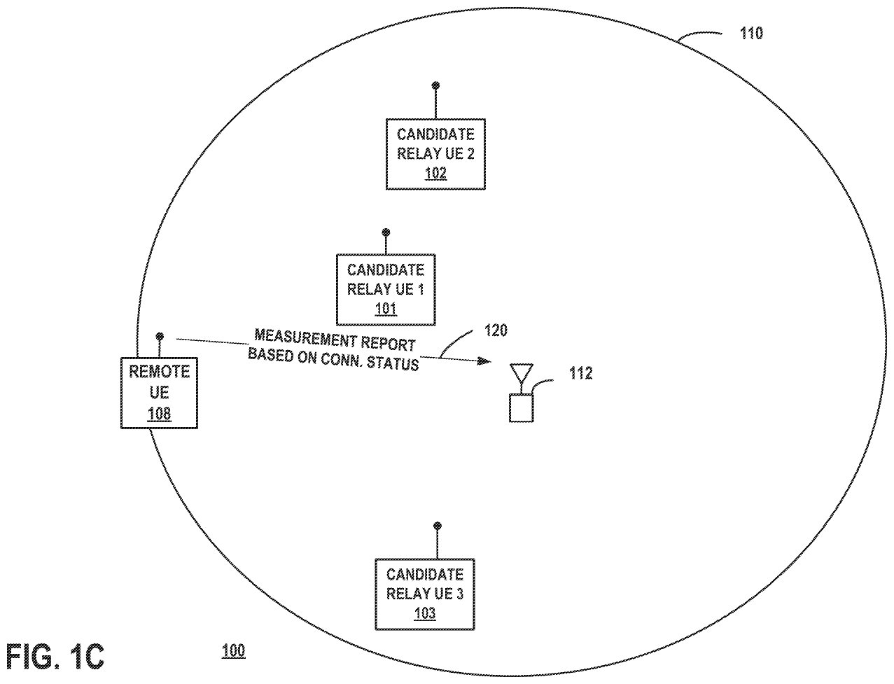

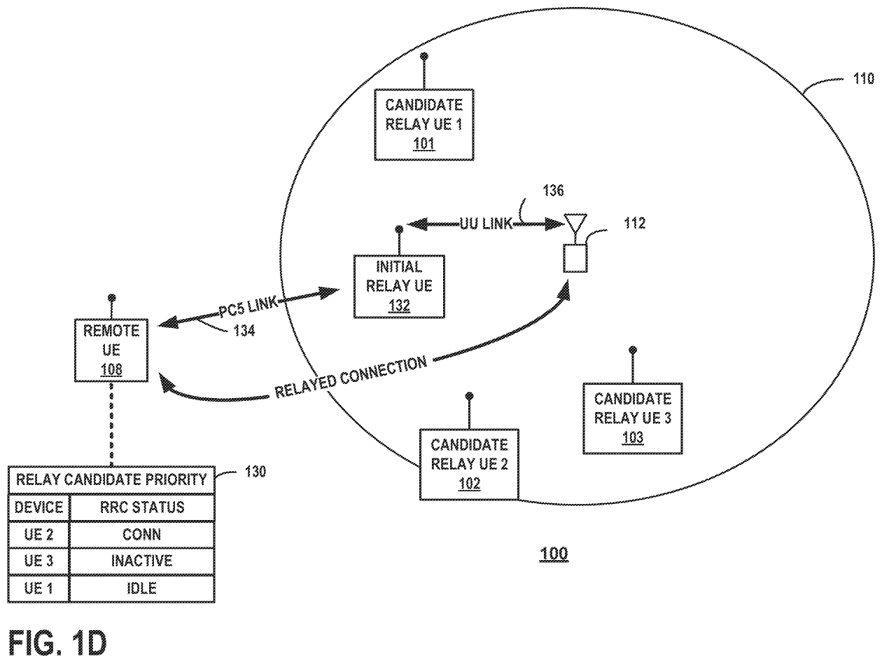

FIG. 1A is a block diagram of a communication system 10 for an example where a candidate relay UE device 12 transmits an RRC connection status 14 to a remote UE device 16. The candidate relay UE device 12 is within a cell coverage area 18 of a base station (gNB) 20. For the example, the candidate relay UE device 12 may be in one of three RRC connection states with the base station 20 where the three states include an RRC connected state (RRC CONN), an RRC idle state (RRC IDLE), and an RRC inactive state (RRC INACTIVE). The candidate relay UE device 12 transmits the RRC connection status 14 indicating the RRC connection status with the base station 20. Accordingly, for the example, the remote UE device 16 may be within or outside the cell coverage area 18 and may be in any several communication modes or transitions. For example, the remote UE device 16 may be directly connected to the base station 20, indirectly connected to the base station 20 through one or more relay UE devices, or may not be connected to the base station 20 when receiving the RRC connection status 14. The remote UE device 16 may be in the RRC connected state with the base station and/or in the RRC connected state with a relay UE device 12. In one example, as discussed below, the remote UE device 16 receives the RRC connection status 14 messages from one or more candidate relay UE devices while being directly connected to the base station 20 before switching to an indirect relayed communication link via a candidate relay UE device. In another example discussed below, the remote UE device is indirectly connected to the base station through an initial relay UE device before performing relay reselection at last partially based on the RRC connection status of candidate relay UE devices.

The RRC connection status may be conveyed to the remote UE devices using any suitable sidelink transmission. In some situations, the RRC connection status is transmitted as part of a sidelink discovery signal where the discovery signal may be a Model A discovery announcement message or a Model B response message. In other situations, the RRC connection status is transmitted in a PC5-RRC message. Such a technique may be useful, for example, where RRC connection status of the relay UE device changes after a PC5 connection is established with the remote UE device.

In another example where a PC5-RRC message may be utilized, the relay UE device is serving as a U2U relay while OoC before moving into the cell 18 and becoming in-coverage. After establishing RRC CONN with the base station 20, the relay UE device transmits a RRC connection status 14 to all of the source and destination UE devices the relay device is serving. The RRC connection status may then be utilized by the source and destination UE devices in performing relay reselection. For example, the relay UE device may inform the source UE device when the destination UE device is no longer directly reachable by the relay UE device but, since the relay UE device is in RRC CONN with the base station, the source UE device may determine that connection through the relay UE device and the base station is preferred to other options. The source UE device, therefore, stays with the same relay UE device to reach the destination UE device via U2N relaying since establishing the connection through a RRC CONN relay is quicker than establishing a relayed connection through a relay UE device that is in-coverage but is not in RRC CONN. In addition, where the source UE device is already PC5 connected to the original relay UE, the process of performing relay reselection would require several exchanges of control messages both at the PC5 link and the Uu link (e.g., PC5-S message to release the current relay UE device, Direct communication Request message towards the new relay UE device, etc.) before traffic data could resume.

In a third example where a PC5-RRC message may be used to convey the RRC connection status, the relay UE device is released by the gNB to RRC IDLE or RRC INACTIVE after a PC5 connection is established with a remote UE device but before the remote UE device is RRC CONN with the base station. Such a scenario may include the relay UE device transmitting a discovery signal indicating the relay UE device is in RRC CONN status and the remote UE device establishing the PC5 connection before the gNB releases the relay UE device from RRC CONN.

FIG. 1B is a block diagram of a communication system 100 for an example where candidate relay UE devices 101-103 each transmit an RRC connection status 104-106 that are received by a remote UE device 108. The system 100 of FIG. 1B is an example of the system 10 of FIG. 1A. The candidate relay UE devices 101-103 are within a cell coverage area 110 of a base station (gNB) 112. For the example, the candidate relay UE devices 101-103 may be in one of three RRC connection states with the base station 100 where the three states include an RRC connected state (RRC CONN), an RRC idle state (RRC IDLE), and an RRC inactive state (RRC INACTIVE). Each candidate relay UE device 101-103 transmits the RRC connection status 104-106 indicating the RRC connection status with the base station 20.

For the example, each RRC connection status 104-106 is transmitted in a sidelink discovery message. For the example, a first candidate relay UE device 101 is in the RRC IDLE state with the base station 112 and transmits an RRC connection status 104 indicating the relay UE device 101 is in RRC IDLE. A second candidate relay UE device 102 is in the RRC CONN state with the base station 112 and transmits an RRC connection status 105 indicating the relay UE device 102 is in RRC CONN. A third candidate relay UE device 103 is in the RRC INACTIVE state with the base station 112 and transmits an RRC connection status 106 indicating the relay UE device 103 is in RRC INACTIVE.

For the examples herein, the remote UE device 108 receives the RRC connection status 104-106 from the three candidate relay UE devices where the status information facilitates communication link management of a connection to the base station. In one example discussed below, the received RRC connection status information of the candidate relay UE devices facilitates switching from direct (without a relay UE device) communication to indirect (with a relay UE device) communication between the remote UE device 108 and the base station 112. In another example, the remote UE device prioritizes the candidate relay UE devices for relay reselection at least partly based on their connection status. In addition to the increased latency for the remote UE device to connect with the base station, (re)selecting a relay UE device that is in either RRC IDLE or RRC INACTIVE would mean the relay UE device still needs to establish its own RRC connection with the base station which may be denied. Then the remote UE device would need to find another candidate relay UE device for connection to the base station.

FIG. 1C is a block diagram of the system 100 for an example where the remote UE device 108 transmits a measurement report 120 based on received RRC connection status of the candidate relay UE devices 101-103. The scenario of FIG. 1C is an example of the situation of FIG. 1B where the RRC connection status information is used to generate a measurement report 120. For the example, the RRC connection status 104-106 of each candidate relay UE device is received in a discovery signal transmitted by the candidate relay UE device providing the RRC connection status. The remote UE device measures the quality of the signals received from the candidate relay UE devices 101-103. A suitable technique includes measuring the Sidelink Discovery Reference Signal Received Power (SD-RSRP) levels of discovery signals transmitted by the candidate relay UE devices and received at the remote UE device. For the example, the discovery signals including the RRC connection status are measured although measurements may be taken of other discovery signals in some situations. The remote UE device generates a measurement report based on the measured SD-RSRP levels and the RRC connection status of the candidate relay UE devices 101-103. The measurement report at least includes a measured SD-RSRP level associated with a UE identifier identifying the candidate relay UE device that transmitted the measured signal. For the example, the measurement report only includes candidate relay devices and SD-RSRP measurements for candidate relay UE devices reporting a status or RRC connected (RRC CONN). In one example, the measurement report is used by the base station 112 to select a target relay UE device for switching from direct communication to indirect communication via the target relay UE device. Since only the RRC connected candidate relay UE devices are identified in the measurement report, the target relay UE device selected from the candidate relay UE device by the base station is in RRC CONN. As discussed with reference to FIG. 1B, the second candidate relay UE device 102 is the only candidate relay UE device in the example that is in RRC CONN. As a result, the second candidate relay UE device 102 is the only candidate relay UE device identified in the measurement report 120 for the example.

The transmission of the measurement report may be triggered by a message from the gNB 112 or may be triggered by an event detected at the remote UE device 108. For example, the remote UE device 108 may generate the measurement report in response to detecting a specified criteria regarding the quality of the connection to the gNB and the quality of an alternate connection to the gNB. For example, the trigger to generate a measurement may be based on a determination that the Uu connection to the gNB has fallen below a first threshold and a connection to a candidate relay UE device is above a second threshold. In some situations, the generation of the measurement report may be triggered when at least one candidate relay UE device has a SD-RSRP greater than a threshold without evaluating the Uu connection.

FIG. 1D is a block diagram of the system 100 for an example where a remote UE device 108 is connected to the base station 112 through a relayed connection and maintains a candidate relay priority list 130 based, at least partially, on RRC connection status of candidate relay UE devices 101-103. The remote UE device 108 uses the candidate relay priority list 130 for relay reselection. In some situations, the candidate relay priority list 130 is generated when the relay reselection procedure is initiated. In other situations, the candidate relay priority list 130 is generated prior to a trigger initiating the relay reselection procedure.

The example begins with the remote UE device 108 connected to the serving base station (gNB) 112 through an initial relay UE device 132 where the remote UE device 108 is out of coverage (OoC). The remote UE device 108, therefore, is outside of the coverage cell 110 provided by the base station 112. In other situations, the remote UE device 108 may be in coverage of the cell 110. The relayed connection between the remote UE device 108 and the base station 112 includes a PC5 communication link 134 between remote UE device 108 and the initial relay UE device 132 and a Uu link 136 between the initial relay UE device 132 and the base station (gNB) 112.

For the example, the RRC connection status indicators 104-106 are transmitted as part of a discovery message where the discovery message may be a Model A message or a Model B response message. In some situations, the transmission of an RRC connection status indicator is in response a change in RRC connection status at the relay UE device. A change in RRC connection status, for example, may trigger the transmission of a Model A discovery message with the RRC connection status indicator. The RRC connection status indicators 104-106 may be any information or identifier that indicates to another UE device (e.g., remote UE device 108) the current RRC connection status of the relay UE device transmitting the indicator. For the example, the RRC connection status indicator indicates one of the following three status states in accordance with one or more revisions of the 3GPP New Radio (NR) V2X communication specification: RRC connected (RRC CONN), RRC idle (RRC IDLE) or RRC inactive (RRC INACTIVE). In accordance with the example of FIG. 1B discussed above, the remote UE device 108 maintains a candidate relay priority list 130 where the candidate relay UE devices 101-103 are prioritized for relay service based, at least partially, on the RRC connection status. A candidate relay UE device in the RRC CONN state is prioritized higher than a candidate relay UE device in the RRC INACTIVE state. A candidate relay UE device in the RRC IDLE state has the lowest priority. The prioritization may be based on additional factors. For example, the prioritization may be based on the measured SD-RSRP levels of the discovery signals received from the candidate relay UE devices. The prioritization, therefore, may be based on the combination of the connection status and the SD-RSRP level as well as other criteria. Where two candidate relay UE devices have the same connection status, the candidate relay UE device with the higher measured SD-RSRP is assigned a higher priority. Usually in network planning, a cell edge corresponds to an RSRP level that is better than −120 dBm. Similarly, for SD-RSRP, the preference would also be for selecting candidate relay UE devices at an SD-RSRP level that is greater than −120 dBm, although lower levels may still work as long as the level is above the sensitivity level of the UE device. Therefore, if the measured SD-RSRP for a candidate relay UE device in RRC CONNECTED is just under −120 dBm, while another candidate relay UE device in RRC IDLE is above −120 dBm, the remote UE device may decide to connect with the candidate UE device in RRC IDLE. This especially may be the case where the remote UE device and the candidate relay UE device are in relative motion.

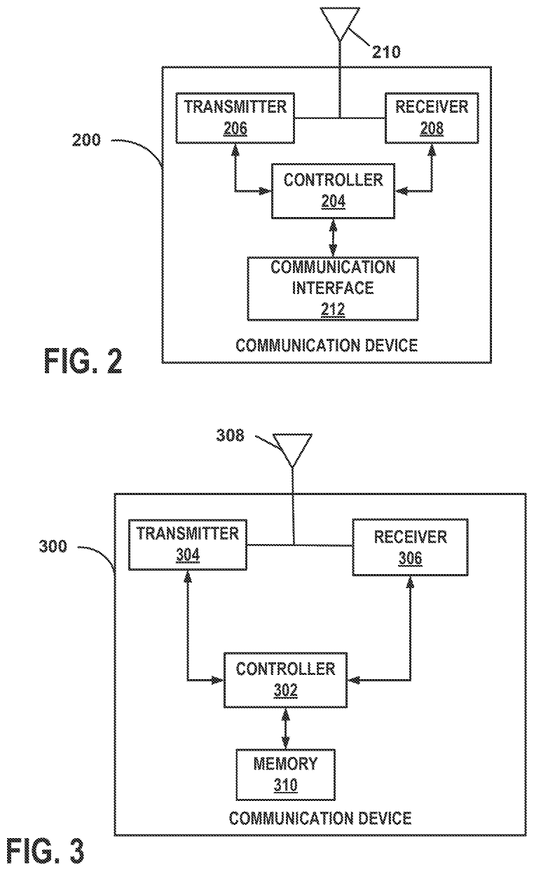

FIG. 2 is a block diagram of an example of a base station 200 suitable for use as the base station 112 and any base station providing a cell or otherwise serving any of the UE devices. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base stations 112, 200 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. In some circumstances, the antenna 210 may include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 12, 16, 101-103, 108, 132. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

The communication device 300 include memory 310 in addition to memory that is part of the controller 302. Information such as candidate relay prioritization list 130 may be stored and maintained on the memory 310, the controller, or a combination of the two.

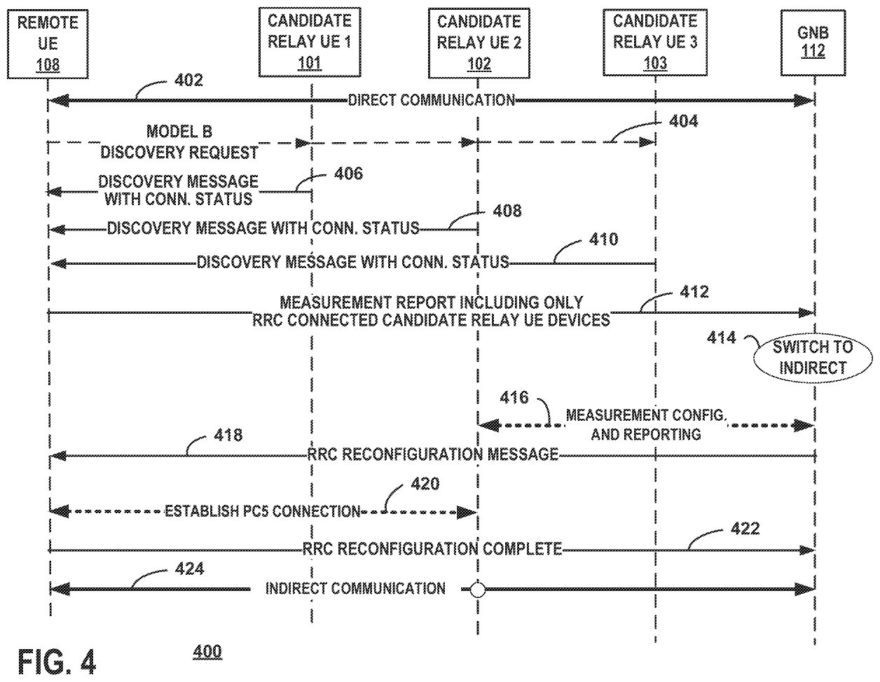

FIG. 4 is a message diagram 400 for an example of relay link management for direct to indirect switching where the remote UE device 108 sends a measurement report for RRC connected candidate relay UE devices. Although FIG. 4 shows three candidate relay UE devices 101-103, any number of candidate relay devices may be involved in the messaging. The example begins with the remote UE device 108 connected to the base station (gNB) 108 via a direct connection 402. Uplink data and downlink data are exchanged between the remote UE device 108 and the gNB 112 over the direct Uu communication link 402.

At transmission 404, a Model B discovery request is sent to the nearby candidate relay UE devices. In some situations, the Model B discovery request may be omitted. Accordingly, the arrow representing the Model B discovery request is illustrated with a dashed line to indicate that the transmission may not be needed. For example, where Model A discovery messages are received from the candidate relay UE devices, the Model B request may not be needed.

At transmission 406, a discovery message is sent from the candidate relay UE device 101. At transmission 408, a discovery message is sent from the candidate relay UE device 102. At transmission 410, a discovery message is sent from the candidate relay UE device 103. The discovery messages of the transmissions 406, 408, 410 may be Model A discovery announcement messages or may be Model B discovery response messages. For the example, discovery messages include an RRC connection status notification indicating the RRC connection status of the relay UE device transmitting the discovery message. The remote UE device 108 receives the discovery messages and evaluates received signals and information as part of the relay reselection procedure. For the examples, the remote UE device measures the SD-RSRP levels of the received discovery messages and evaluates the RRC connection status of the candidate relay UE devices 101-103.

At transmission 412, the remote UE device sends a measurement report to the gNB 112 where the measurement report includes signal quality measurements for candidate relay devices reporting an RRC connection status of RRC connected (RRC CONN). In accordance with the examples discussed above, the second candidate relay UE device 102 reports its status as RRC CONN. Accordingly, the measurement report includes the signal quality measurement, such as the SD-RSRP level of the discovery signal 408, for the second candidate relay UE device 102. The measurement report may also include signal quality measurements of other gNBs in some situations.

At event 414, the gNB 112 determines that communication with the remote UE device 108 should be switched from a direct connection to an indirect connection via a relay UE device. The decision by the gNB 112 to switch to indirect communication may be based on any combination of factors such as, which event triggered the measurement reporting, the SD-RSRP level(s), the RRC connection status, and the congestion level of the candidate relay UE (the gNB may know how many remote UE devices are already connected to a particular candidate relay UE).

At event 416, the remote UE device 108 and the gNB 112 perform a measurement configuration and reporting procedure. The line representing the event 416 is shown as dashed to indicate the process may be not be needed where the gNB 112 already has the information that would be obtained from the measurement configuration and reporting procedure.

After obtaining measurement report from the second candidate relay UE device and any other candidate relay UE device included in the measurement report 120 provided by the remote UE device, the gNB 112 selected a relay UE device (target relay UE device). For the example, the gNB 112 selects the second candidate UE device 102 for the relayed connection.

At transmission 418, the gNB 112 transmits an RRC reconfiguration message to the remote UE device. The RRC reconfiguration message initiates the switch from the direct communication link 402 to an indirect communication link via the second candidate relay UE device 102. In some situations, the order of the transmissions 416, 418 cane be switched.

At even 420, a PC5 connection is established with the second candidate relay UE device 102. In some situations, the PC5 connection may already be established and event 420 is not needed.

At transmission 422, the remote UE device 108 sends an RRC reconfiguration complete message to the gNB 112. Communication between the remote UE device 108 and the gNB 112 continues over the indirect communication link 424 which includes a relay connection through the second candidate relay UE device 102.

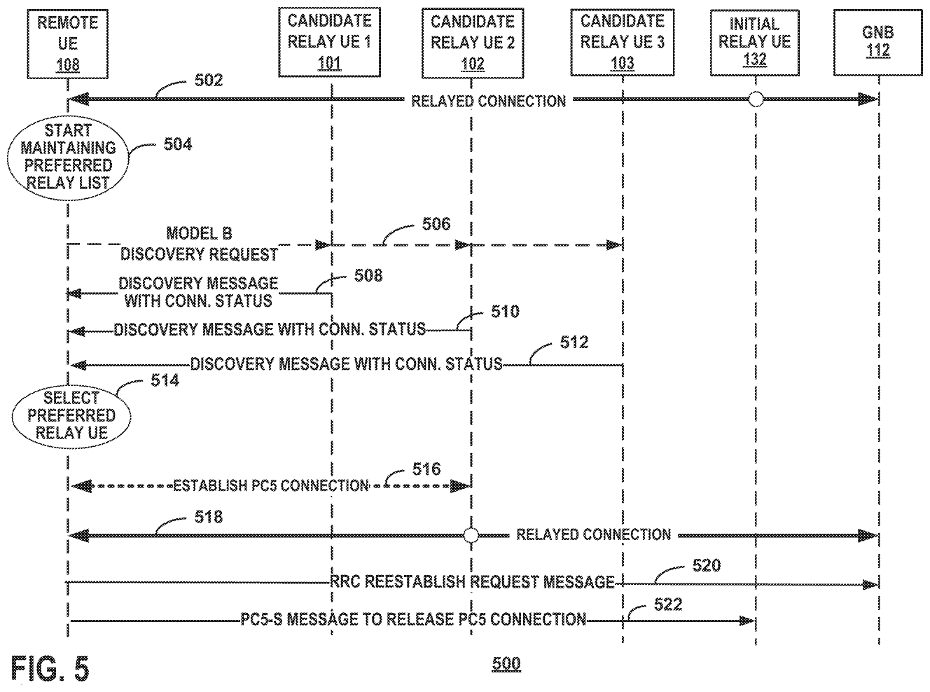

FIG. 5 is a message diagram 500 for an example of relay link management where the remote UE device 108 maintains a preferred relay list based on the connection status of candidate relay UE devices. Although FIG. 5 shows three candidate relay UE devices 101-103, any number of candidate relay devices may be involved in the messaging. The example begins with the remote UE device 108 connected to the base station via a relay connection through the initial relay UE device 102 that includes a PC5 link 502 to the initial relay UE device 132. At event 504, the remote UE device 108 begins to maintain a preferred candidate relay UE device list. The event 504 may be part of relay reselection procedure and/or may be triggered by an event such as a radio link failure (RLF). The remote UE device 108 maintains a candidate relay priority list 130 where the candidate relay UE devices 101-103 are prioritized for relay service based, at least partially, on their RRC connection status and measured SD-RSRP level. The remote UE device 108 uses the discovery procedure of the transmissions 508, 510, 512 to identify and prioritize the relay UE devices. In some situations, the remote UE device 108 waits for another event before performing reselection. In other situations, other events may trigger the remote UE device to take action. For example, the remote UE device 108 may perform relay reselection when an elapsed time since receipt of the RLF notification exceeds a time period threshold. In another example, the remote UE device 108 performs relay reselection when it is determined that the PC5 link with the initial relay UE device 132 has been released, has fallen below minimum quality threshold, or is otherwise unusable.

At transmission 506, a Model B discovery request is sent to the nearby candidate relay UE devices. In some situations, the Model B discovery request may be omitted. Accordingly, the arrow representing the Model B discovery request is illustrated with a dashed line to indicate that the transmission may not be needed. For example, where Model A discovery messages are received from the candidate relay UE devices, the Model B request may not be needed.

At transmission 508, a discovery message is sent from the candidate relay UE device 101. At transmission 510, a discovery message is sent from the candidate relay UE device 102. At transmission 512, a discovery message is sent from the candidate relay UE device 103. The discovery messages of the transmissions 508, 510, 512 may be Model A discovery announcement messages or may be Model B discovery response messages. For the example, discovery messages include an RRC connection status notification indicating the RRC connection status of the relay UE device transmitting the discovery message. The remote UE device 108 receives the discovery messages and evaluates received signals and information as part of the relay reselection procedure. For the examples, the remote UE device measures the SD-RSRP levels of the received discovery messages and evaluates the RRC connection status of the candidate relay UE devices 101-103.

At event 514, the remote UE device selects a preferred candidate relay UE device for establishing a relay connection to the gNB 112. The event 514 may be part of the relay reselection procedure. In some situations, the remote UE device 108 maintains the preferred candidate relay UE device list and selects to most preferred relay UE device for reselection in response to an event. For example, where RLF has occurred and a connection cannot be reestablished though the initial relay UE device 132, the remote UE device 108 may determine that a new relay connection should be established through the preferred relay UE device.

At event 516, a PC5 link is established with the preferred candidate relay UE device. For the example, the preferred candidate relay UE device is the second candidate relay UE device 102. A relayed connection 518 is subsequently established with the gNB 112.

At transmission 520, the remote UE device 108 sends an RRC Re-establishment Request message via the second relay UE device 102.

At transmission 522, a PC5-S message is sent to the initial relay UE device to release the PC5 connection.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A remote user equipment (UE) device comprising:
a transceiver comprising a transmitter and a receiver, the transceiver configured to communicate with a base station over an initial communication link,
the receiver configured to receive, from a first candidate relay UE device, a first Radio Resource Control (RRC) connection status indicator indicating a current connection status of the first candidate relay UE device to a base station and to receive, from a second candidate relay UE device, a second RRC connection status indicator indicating a current connection status of the second candidate relay UE device to the base station,
the transceiver further configured to switch communication from the initial communication link to a relayed communication link to communicate with the base station over the relayed communication link through a preferred candidate relay UE, the preferred candidate relay UE device selected from the first candidate relay UE device and the second candidate relay UE device based, at least partially, on the first RRC connection status indicator and the second RRC connection status indicator.

2. The remote UE device of claim 1, wherein each of the RRC status indicators is indicative of one of a plurality of RRC connected states comprising connected (RRC CONN), idle (RRC IDLE), or inactive (RRC INACTIVE).

3. The remote UE device of claim 2, wherein the initial communication link is a direct communication link between the remote UE device and the base station, the remote UE device further comprising:
a controller configured to, in response to a quality of the direct communication link falling below a direct link quality threshold, generate a measurement report comprising a link quality measurement associated with a relay UE device identifier for each connected state candidate relay UE device transmitting an RRC connected status indicator indicating the RRC CONN state and omitting link quality measurements all other candidate relay UE devices.

4. The remote UE device of claim 1, wherein the controller configured to generate a measurement report in response to a quality of the direct communication link falling below a direct link quality threshold and determining that at least one link to a candidate relay UE device is above relay threshold.

5. The remote UE device of claim 4, wherein the controller is further configured to determine the quality of the direct communication link has fallen below the direct link quality threshold and to determine that at least one link to a candidate relay UE device is above relay threshold based on measurements at the remote UE device.

6. The remote UE device of claim 4, wherein the receiver is configured to receive, from the base station, a measurement report configuration identifying criteria for generating the measurement report, the controller configured to generate the measurement report in response to determining the criteria for generating the measurement report has been met.

7. The remote UE device of claim 4, wherein:
the receiver is further configured to receive an RRC reconfiguration message from the base station, the RRC reconfiguration message identifying the preferred candidate relay UE device; and
the controller is further configured to establish, in response to the RRC reconfiguration message, the relayed communication link to the base station through the preferred candidate relay UE device.

8. The remote UE device of claim 2, wherein the initial communication link is a first relay communication link through an initial relay UE device, the controller configured to select the preferred candidate relay UE device.

9. The remote UE device of claim 2, wherein the first RRC connection status notification is received in a first discovery message from the first candidate relay UE device and the second RRC connection status notification is received in a second discovery message from the second candidate relay UE device.

10. A relay user equipment (UE) device comprising:
a transmitter configured to transmit a Radio Resource Control (RRC) connection status indicator indicating a current connection status of the first candidate relay UE device to a base station, the RRC connection status indicator transmitted over a sidelink communication link to at least one remote UE device.

11. The relay UE device of claim 9, wherein the RRC status indicator is indicative of one of a plurality of RRC connected states comprising connected (RRC CONN), idle (RRC IDLE), or inactive (RRC INACTIVE).

12. The relay UE device of claim 10, wherein the transmitter is configured to transmit the RRC connection status indicator in a discovery message.

13. The relay UE device of claim 11, wherein discovery message is one of Model A discovery message and a Model B discovery message.

14. A base station comprising:
a transceiver comprising a transmitter and a receiver, the transceiver configured to communicate with a remote user equipment (UE) device over a direct communication link,
the receiver configured to receive, from the remote UE device measurement report comprising link quality measurements of signals received from candidate relay UE devices at the remote UE devices, link quality measurements only including link quality measurements of signals received from candidate relay UE devices in a Radio Resource Control (RRC) connection status of connected (RRC CONN) with the base station;
a controller configured to identify one of the candidate relay UE devices as a target relay UE device, the transmitter further configured to transmit an RRC reconfiguration message to the remote UE device to switch the remote UE device from the direct communication link to an indirect communication link through the target relay UE device.

15. The base station of claim 14, wherein the measurement report is generated based on RRC status indicators transmitted by the candidate relay UE devices.

16. The base station of claim 15, where the measurement report is generated based on RRC status indicators transmitted by the other candidate relay UE devices not in the RRC connected (RRC CONN) state by omitting measurements of signals transmitted by the other candidate relay UE devices.

17. The base station of claim 16, wherein RRC status indicators are indicative of one of a plurality of RRC connected states comprising connected (RRC CONN), idle (RRC IDLE), or inactive (RRC INACTIVE).

18. The base station of claim 17, wherein the transmitter is further configured to transmit a measurement configuration message to the remote UE device, the measurement configuration message indicating criteria for triggering generation of the measurement report

19. The base station of claim 18, wherein the criteria comprise a direct link minimum quality threshold of the direct communication link.

20. The base station of claim 19, wherein the criteria comprise a candidate relay minimum quality threshold of a PC5 link.
